(19) United States
(12) Patent Application Publication
(10) Pub. No.: US 2004/0178683 A1
(43) Pub. Date: Sep. 16, 2004

(54) System for control of electrical devices

(76) Inventors: Jesse Steven Hermetz, Brampton (CA); Ian Paul Stanley, Bramalea (CA); James Michael Hermetz, Brampton (CA)

Correspondence Address: MARKS & CLERK, 1075 NORTH SERVICE ROAD WEST, SUITE 203, OAKVILLE, ON, L6M 2G2, CA

(21) Appl. No.: 10/384,599

(22) Filed: Mar. 11, 2003

(51) Int. Cl. H01H 43/00; H01H 7/00

(52) U.S. Cl. 307/141

(57) ABSTRACT

A system for control of electrical devices is provided. An adapter is provided having an electrical power interface for connecting to an electrical power supply, a switch to complete or break an electrical power circuit, a timer module operable to receive and maintain time information and timing instructions associated with criteria for completing or breaking the electrical power circuit, and a programming interface for receiving the time information and timing instructions from a programming module. In use, a user modifies the time information and/or one or more timing instructions via the programming module, connects the programming module to the adapter for communication of the modified time information and/or timing instructions and disconnects the programming module from the adapter, the adapter remaining operable to complete or break the electrical power circuit to which an electrical device is connected even after the disconnection of the programming module.

### FIELD OF THE INVENTION

The present invention relates generally to a system for control of electrical devices. More specifically, the present invention relates to a portable programming module that is coupleable to an adapter to program the adapter.

### BACKGROUND OF THE INVENTION

Timer devices are known. A common example of a timer device is a household timer that can be plugged into an electrical power outlet receptacle and itself has an electrical power outlet into which an electrical device can be plugged. A timer mechanism on the portable timer device allows a user to set one or more time periods during which electrical power is to be provided to the electrical device plugged into it. Typically, the timer mechanism has a user interface consisting of a rotatable dial with radial markers to allow the user to set these time periods. Alternatively, the timer device can have a user interface comprised of an input panel and a display, the input panel consisting of a number of depressible buttons, such as “Mode”, “Event On/Off“, “Reset”, “Day”, “H+” and “M+”.

A problem with these devices is that they require manual programming every time changes are required, including the case where a loss of power has been experienced. Where two or more timers are employed, the interface through which the user programs the timer device may vary between devices.

Further, a number of solutions exist that are operable to replace a standard electrical switch or outlet receptacle, whereby the timer device is affixed to the electrical box and has a faceplate with some type of user interface. The timer device can control the power along a power circuit to which it is connected. Alternatively, the timer device can provide a parallel electrical circuit appended to the electrical circuit to which the timer device is connected to which an electrical device can be coupled and, by completing or breaking the circuit, the power to the electrical device can be controlled.

A problem with these devices is that they generally can only be programmed manually while the user is in front of the device. As a result, where a number of timer devices are employed, it can be onerous for a user to modify the programmed timing instructions of each deployed device to compensate for a change in schedule, such as can be required where a user is going on vacation or a business trip, or to compensate for the change in seasons.

Another solution currently sold by IBM Corporation known as Home Director requires the installment of customized receptacles and switches that are connected via Ethernet cabling to a central connectivity center. A personal computer executing the appropriate software and connected to the connectivity center via Ethernet cable can then be used to control the devices.

The disadvantages of this solution include the requirement for the costly replacement of any outlet receptacle to be controlled with a proprietary one, the “pulling” of Ethernet cables through walls where such a network does not exist and the presence of a computer that is kept active to allow for control the various devices attached thereto.

Where the devices to be controlled include a battery-operated or initiated device such as an automotive vehicle, one solution has been to integrate a fixed timing device (e.g a remote car starter) into the circuit of the starter that can be programmed to complete the circuit at a set time. For example, the devices can start the car or heat the engine block of the car (as may be required in colder climates, where it is desired to warm a car prior to its use). The user interface used to program the timing instructions, along with the timing device, is affixed in the car cabin interior. As a result, the user is required to be stationed in the car to program the timing device.

Accordingly, there is a need for a method of allowing a user to easily program the timing instructions for one or more timing devices using a common interface. Further, there is a need for a system, apparatus and method of providing control of an electrical device wherein the user is preferably not required to physically be situated proximal to the device controlling the electrical power. Still further, there is a need for a method of restoring the state of timer devices after a loss of power.

### SUMMARY OF THE INVENTION

In an aspect of the invention, there is provided a system for control of electrical devices, comprising: at least one adapter having an electrical power interface operable to be connected to an electrical power source, a switch coupled to the electrical power interface and moveable between a closed position, wherein an electrical power circuit is supplied to an electrical device coupled to the power source, and an open position, wherein the electrical power circuit is open to disconnect the electrical device from the electrical power source, a first timer module coupled to the switch and operable to maintain time information and at least one timing instruction associated with the time information, the timing instruction including at least one timing criterion and a power instruction associated with the switch, and a programming interface operable to receive a change to the time information and the at least one timing instruction; a programming module having a display for displaying the time information and the at least one timing instruction, an input interface for allowing a user to modify the time information and the at least one timing instruction, and operable to be connected to the programming interface of the adapter via a communications interface to update the at least one modified timing instruction to the adapter via the programming interface, after which the programming module can be operatively disconnected from the adapter, wherein the adapter is operable to control the second electrical power circuit after the programming module is disconnected therefrom.

In an implementation of the first embodiment, the programming module additionally comprises a second timer module operable to maintain the at least one timing instruction and/or the time information.

In an implementation of the first embodiment, the programming module is additionally comprised of an audible alarm module and the programming module is operable to trigger the audible alarm module based on at least one audible alarm timing instructions programmed via the input interface. The at least one audible alarm timing instructions correspond to one of the at least one timing instructions.

In an implementation of the first embodiment, there are at least two of the adapters, and the second timer module of the programming module is operable to maintain at least two subsets of the timing instructions for at least two of the adapters. Each of the adapters can be provided a separate identification, wherein the programming module is operable to associate each of the adapters with at least one of the at least two subsets of the timing instructions based on the separate identifications. Further, the programming module can be operable to communicate the at least one of the at least two subsets of the timing instructions selectively according to the identification of the adapter to which the programming module is connected.

The at least one timing criterion can be at least partially composed of a pre-set time.

The adapter can include an independent power supply, such as a battery, to power the adapter when the electrical power supply experiences a power fluctuation. A audible alarm (such as a low voltage “chirp”) can be provided to warn of low battery power.

The programming module is a personal digital assistant.

The programming interface and the communications interface can be comprised of a set of electrical contacts, such as multi-pin (e.g. a four-pin) electrical connectors. Alternatively, the programming interface can communicate with the communications interface via infrared, powerline communications networking or any other suitable networking interface.

The adapter can be equipped with an AC/DC adapter to convert an alternating current from the electrical power supply to a direct current for operation of the timer module.

In an implementation of the first embodiment, the electrical device is a remote car starter. In another implementation, the electrical device is an automotive block heater.

In accordance with a second embodiment of the invention, there is provided a programming module for use with programmable power adapters, comprising: a display for displaying time information and at least one timing instruction associated with the time information and maintained by a programmable power adapter; an input interface for allowing a user to make at least one modification the time information and the at least one timing instruction; and, a communications interface operable to communicate the at least one modification to a programming interface of the adapter operable to control a power supply to an electrical device in accordance with the at least one timing instruction.

The programming module can additionally comprise: a timer module operable to maintain the time information and at least one timing instruction. The timer module can be operable to compare the at least one timing instruction with at least one deployed timing instruction on the adapter.

The programming module can be a personal digital assistant, a computer, or any other suitable device.

In an implementation of the second embodiment, the input interface consists of at least one button.

The communications interface can be an infrared transmitter, a powerline communications network adapter, a wireless network adapter, a set of electrical contacts or any other suitable interface suitable for communications with the adapter.

In a third embodiment of the invention, there is provided an adapter for controlling an electrical device, comprising: an electrical power interface for connection to an electrical power supply; an electrical power outlet operable to supply electrical power to an electrical device; a switch connected to the electrical power supply and operable to move between a closed position, whereby the electrical power is provided to the electrical device, and an open position, whereby the electrical power is disconnected from the electrical device; a timer module coupled to and operable to move the switch between the closed position and the open position based on time information and at least one timing instruction associated with the time information maintained by the timer module, the timing instruction including at least one criterion and a power instruction associated with the switch; and a programming interface operable to receive a change to the time information and the at least one timing instruction.

In an implementation of the third embodiment, the electrical power interface is operable to be connected to a household electrical power outlet. In another implementation, the electrical power interface is operable to be connected to an automotive battery.

In an implementation of the third embodiment, the electrical device is a remote car starter.

The programming interface can be a set of electrical contacts, a wireless network adapter or any other suitable interface for receiving modifications to the time information and/or the timing instructions.

The adapter can additionally comprise: a sensor operable to provide sensory information to the timer module associated with at least one of the at least one timing instruction. The sensor can be a photo sensor, a motion sensor, a microphone, a thermostat, or any other suitable device.

### BRIEF DESCRIPTION OF THE DRAWINGS

Preferred embodiments of the present invention will now be described, by way of example only, with reference to the attached Figures, wherein:

FIG. 1 shows a schematic representation of the invention in accordance with an embodiment thereof;

FIG. 2 shows an isometric view of an adapter in accordance with an embodiment of the invention;

FIG. 3 shows an isometric view of a programming module in accordance with an embodiment of the invention; and

FIG. 4 shows a schematic representation of the invention when deployed in an automobile.

### DETAILED DESCRIPTION OF THE INVENTION

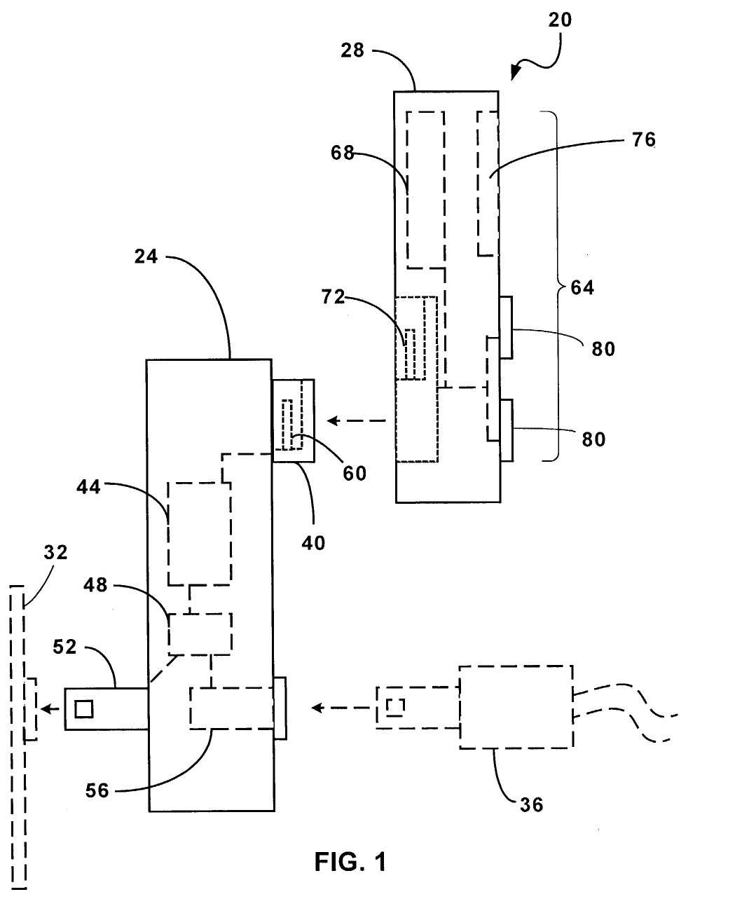

A system for control of electrical devices in accordance with an embodiment of the invention is generally shown at 20 in FIG. 1. An adapter 24 programmable via a programming module 28 and operable to be connected to an electrical power supply 32 and receive an electrical device 36.

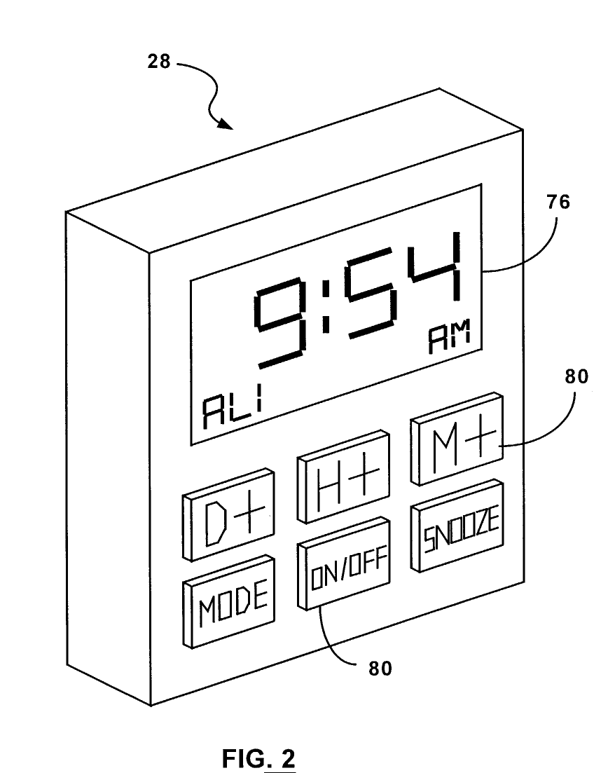

In the embodiment of the invention depicted in FIGS. 1 and 2, adapter 24 is connectable to an electrical power outlet via a set of prongs and, in turn, is operable to receive an electrical device which could have otherwise been connected directly to the electrical power outlet. Adapter 24 is shown having a programming interface 40, a timer module 44, a switch 48, an electrical power interface 52 and an electrical power outlet 56.

Programming interface 40 is shown as a number of electrical contact pins 60 in accordance with a present embodiment of the invention.

Timer module 44 is connected to programming interface 40 to receive a set of one or more instructions therefrom and consists of processing and memory means as required to receive, maintain and update time information and at least one timing instruction associated with the time information. For example, the time information can be the current day/date and time and the timing instruction can be a pre-set time and/or day/date upon which a specific event, such as the provision of power to electrical power outlet 56. Other examples of timing instructions include the termination of power to electrical power outlet 56 fifteen minutes after the detection of a pre-determined amount of light and the powering of electrical power outlet 56 upon the earlier of a pre-set time and the detection of an audio signal of a minimum decibel level.

Switch 48 is any known apparatus for opening and closing an electrical circuit capable of powering a device connected thereto. Electrical power interface 52 is operable to allow adapter 24 to connect and draw power from a first electrical power circuit. In a present embodiment of the invention, electrical power interface 52 is comprised of a set of electrical prongs operable to be inserted into a household electrical power outlet to draw power therefrom.

Electrical power outlet 56 is shown being operable to allow an electrical device with an electrical interface, such as a plug, to be connected to adapter 24 for receipt of power therefrom. In accordance with a present embodiment of the invention, switch 48 is operable to draw electrical power from electrical power interface 52 and, upon the satisfaction of the appropriate conditions, provide power to a second electrical circuit to power electrical device 36 connected thereto via electrical power outlet 56.

Programming module 28 is any known computing device capable to receive one or more timing instructions and communicate them to adapter 24 via programming interface 40. In accordance with a present embodiment of the invention, programming module 28 is a travel alarm clock having a user interface 64, a timer module 68, and a communications interface 72. User interface 64 is shown consisting of a display 76 and an input interface consisting of a number of buttons 80. Display 76 can be a liquid crystal display, light-emitting diode or any other type of display known in the art to present information to a user. Buttons 80 can allow a user of programming module 28 to create view and modify one or more timing instructions stored in timer module 68. Further, where programming module 28 maintains time information, such as the current day/date/time, buttons 80 can allow a user to modify the time information. For example, buttons 80 can allow a user to create, select and delete a timing instruction, modify the current day/date and/or time, modify the day/date and/or time for a timing instruction, select whether power is to be turned on or off to electrical device 36 (or not modify the status of the power supply to electrical device 36 connected to adapter 24) upon the satisfaction of the criteria of the timing instruction and, where programming module 28 is a travel alarm clock, select whether an audible alarm is to be sounded upon the satisfaction of the criteria of the timing instruction.

Programming module 28 can be powered via a battery disposed therein or via communications interface 72. In an embodiment, the battery is recharged when programming module 28 is connected to adapter 24 via communications interface 72. Other means for powering programming module 28 will be known to those of skill in the art.

Electrical power supply 32 is any source of direct or alternating current operable to power one or more electrical devices connected thereto. In the present embodiment of the invention, electrical power supply 32 is a household electrical power outlet that is operable to power one or more household electrical devices operable using alternating current.

Electrical device 36 is any device powered by a direct or alternating current. In accordance with a present embodiment of the invention, electrical device 36 is any household electrical device such as a lamp, radio or television.

Now referring to FIG. 2, programming module 28 is shown having a display 76 and six buttons 80. The top row of buttons 80 are labeled “D+”, “H+”, “M+”, allowing a user to change a pre-set day/date/time for a timing instruction or to change the current day/date/time. The bottom row of buttons 80 are labeled “Mode”, “On/off” and “Snooze”, allowing a user of programming module 28 to select the function mode, such as day/date/time set mode or alarm 1 set mode, to specify whether the timing instruction is to turn on or off an electrical device plugged into adapter 24, and, in a preferred embodiment, also provide the functionality expected of a travel alarm clock (referring specifically to the “Snooze” button). Programmable module 28 additionally has an alarm module for generating an audible alarm (not shown).

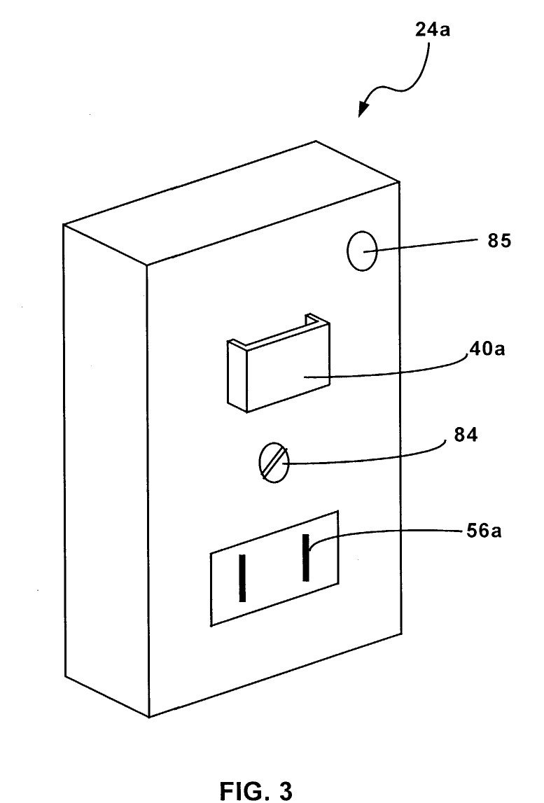

FIG. 3 shows an alternate embodiment of the invention, wherein an adapter 24a, similar to adapter 24 of FIG. 1, having a programming interface 40a and an electrical power outlet 56a, is provided with a sensor 85. Sensor 85 can be light, sound, temperature and/or motion-sensitive or any other type of sensor known to those of skill in the art to allow consideration for external stimuli in the timing instructions.

At the centre of adapter 24a is a screw 84 which passes through adapter 24a and which can be screwed into the screw hole normally found on an electrical outlet once the electrical outlet cover has been removed. In this fashion, adapter 24a can be plugged into an outlet, and then screwed in place in order to prevent adapter 24a from being easily removed from the outlet.

In operation, a user programs programming module 28 with one or more timing instructions. For example, where the user is going on vacation and would like to provide his or her dwelling the appearance that it is occupied, it can be desirable to have one or more electrical devices turned on and off at various times of the day on various days to recreate the externally detectable conditions associated with a household occupied by one or more people such that a potential thief would conclude that the dwelling is occupied and deem the dwelling unsuitable for targeting.

For example, the timing instructions could be, for weekdays: power on at 6:20 am, power off at 7:45 am, power on at 6:40 pm, power off at 11 pm, corresponding to the activity of a person waking up, leaving for work, arriving home from work and going to sleep. It can be desirable to have varying times for the timing instructions for the weekend days to reflect the dwelling's residents' non-work days. Further, it can be desirable add elements of randomness to the above-noted times to more truly reflect typical conditions, such as where a person's arrival time from work can fluctuate from day to day based on traffic, workload, etc. In this case, the above-noted times can be programmed as follows: power on at 6:20 am, power off at 7:45 am ±ten minutes, power on at 6:40 pm±one hour, power off at 11 pm±30 minutes. Other variations will occur to those of skill in the art.

The user enters these timing instructions via buttons 80 and visually confirms his recent and prior entries via display 76. Where one or more changes are made to the timing instructions on programming module 28, programming module 28 must be connected to adapter 24 to impart the new or modified timing instructions. Further, programming module 28 can be operable to communicate time information to adapter 24. The receiving cavity in which communication interface 72 of programming module 28 is located is aligned with programming interface 40 of adapter 24. Upon sliding programming module 28 over programming interface 40 and down, pins 60 are placed in communication with the corresponding contact holes in communications interface 72. In an embodiment of the invention, upon detection of the contact with programming interface 40, programming module 28 initiates a protocol for communicating the timing instructions. Any other method known to those skilled in the art can be used to initiate communication, such as the depression of a button 80 on programming module 28 by a user thereof. The timing instructions resident on programming module 28 can be copied to timer module 44 of adapter 24, overwriting any instructions present thereon. It is contemplated that any method of transferring the timing instructions known to those skilled in the art can be employed, such as a synchronization method capable of conflict resolution.

Upon imparting the timing instructions and/or time information, programming module 28 can be removed from adapter 24. Timer module 44 is operable to maintain and execute the timing instructions upon the satisfaction of the indicated criteria using the power available via electrical power supply 32, via a battery placed in the housing of adapter 24 that recharges when adapter 24 is coupled to electrical power supply 32, via a non-rechargeable battery, etc. Timer module 44 maintains time information related to the timing instructions received from programming module 28 and is operable to check whether any of the criteria for any of the timing instructions have been satisfied at the current time. Upon satisfaction of the criteria for a timing instruction, timer module 44 opens or closes switch 48 to terminate or initiate the supply of power to electrical device 36.

In an embodiment of the invention, programming module 28 is operable to maintain separate timing instructions associated with two or more adapters 24 with which programming module 28 is used, thus providing a common interface through which adapters 24 are programmed. In use, a user programs one or more timing instructions for a specific adapter which are then maintained by programming module 28 for the specific adapter. Upon placing programming module 28 in communication with the specific adapter, programming module 28 can communicate the appropriate timing instructions to the adapter. Adapters 24 can be pre-equipped with individualized identities to allow programming module 28 to recognize a specific adapter and associate the one or more timing instructions with that specific adapter. Alternatively, adapters 24 can be programmably equipped with identifiers by the user of programming module 28, the user of programming module 28 can indicate which set of timing instructions to communicate to a specific adapter 24 to which programming module 28 is or will be in communication with, or the same timing instructions can be communicated to each of adapters 24.

In an implementation of the invention, where programming module 28 is a computing device such as a computer, programming module 28 can be operable to save two or more configurations for a specific adapter, thus allowing a user thereof to select a configuration having one or more timing instructions for communication to the specific adapter. This approach can be desirable in a number of circumstances, such as, for example, where seasonal lighting shifts significantly and household lights are typically turned on earlier, or where warming up an automotive engine is required in winter, but not in the warmer months. Further, where two or more adapters are to be programmed by programming module 28, programming module 28 can be operable to save all the timing instructions for each adapter under a specific configuration and can have two or more configurations to match meteorological or work seasons, or any other distinct periods.

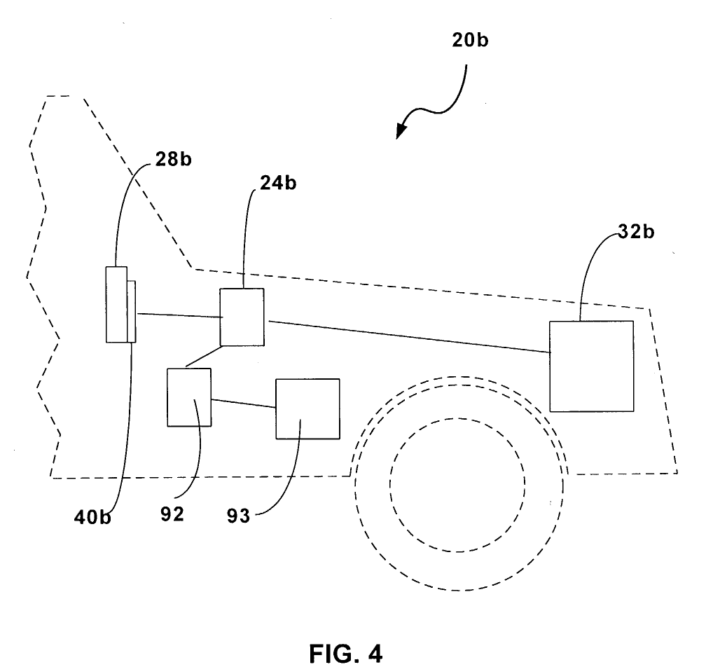

FIG. 4 shows an alternate embodiment of the invention adapter for use with a remote automotive engine starter generally at 20b. Adapter 24b is connected to an electrical power supply 32b (in this case, an automotive car battery) and has a programming interface 40b that is located in the passenger cabin of the automobile. Programming module 28b is shown coupled to programming interface 40b for communication of one or more timing instructions for adapter 24b. Adapter 24b is additionally connected to an automotive remote starter 92 which in turn, is connected to a car starter 93. After programming adapter 24b, programming module 28b can be removed. Then, upon satisfaction of a timing instruction, adapter 24b is operable to supply remote starter 92 with power, thus allowing it to start the engine of the automobile using starter 93. It is to be noted that programming module 28b can be the same as programming module 28, thus providing a user with a common interface for programming the various adapters 24b and 24.

While the embodiments discussed herein are directed to specific implementations of the invention, it will be understood that combinations, sub-sets and variations of the embodiments are within the scope of the invention. For example, while the programming module has been described above as being operable to maintain time information and timing instructions, it is contemplated that the programming module can be simply used to modify the time information and timing instructions on the adapter, in which case, a timer module is not required in the programming module.

Although an adapter that is operable to be connected to a standard household electrical outlet has been described specifically, the adapter can be of a number of other forms. Alternatively, the adapter can be made to fit into a household electrical box and replace an outlet. This configuration can be advantageous in circumstances where it is desirable to disable an electrical outlet altogether, such as for child-proofing purposes. For example, the adapter might also contain a switch which turns off power to the outlet 56 once a plug has been removed. Additionally, adapter 24 might be fitted with covers which fall in place to cover outlet 56 once a plug has been removed. Further, where the adapter replaces an electrical outlet, it can be optionally equipped with power surge protection and can be operable to complete or break the electrical power circuit to which it, and an electrical device connected thereto, is connected.

Although the programming interface of the adapter and the communications interface of the programming module have been shown to be a set of electrical contacts, it is to be understood by those of skill in the art that other means for communicating the timing instructions from the programming module to the adapter can be employed. For example, any number of wireless communication technologies can be used, such as Bluetooth, WiFi, or infrared.

Further, as the adapters are connected to a network of electrical wiring that typically encompasses the dwelling, the adapter can be equipped with a powerline communications network adapter (PCNA), enabling the programming module to be connected to any outlet in the dwelling to program any adapter connected to the dwelling's powerlines. Still further, where a PCNA is employed, a computing device equipped with a corresponding PNA and connected to the powerlines and another communications network, such as the Internet, can be operable to allow remote programming of the adapters.

It will be understood by those of skill in the art that certain variations in the adapter are possible. For example, an adapter can be equipped with two or more electrical outlets to control two or more electrical devices plugged into the single adapter. Further, the timer module of the adapter can be operable to control the power supply to each of these electrical outlets separately.

Further, the adapter can be equipped with an AC/DC adapter where the timer module is suited for operation with direct electrical current.

The timing instructions can be comprised of a number of criteria, such as upon the sensing of specific light, audio and temperature conditions, or upon the triggering of a motion sensor. For example, the adapter can be equipped with a light sensor that can allow a user of programming module to specify a criteria for a timing instruction that would include a light detection component, such as “If 5 pm or later, and environmental light is lower than a pre-determined level, supply power to the outlet.” Alternately, where the adapter is equipped with an audio sensor, the timing instruction could be “If between 11 pm and 6:30 am and a noise of 30 dB or higher is detected, supply power to the outlet.”

The complexity of these timing instructions can increase with the sophistication of the adapter and the programming module. For example, where a computing device with sufficient processing and memory capacity is employed as a programming module, the timing instructions can be comprised of complex nested Boolean criteria.

While the programming module has been described with specificity to travel alarm clocks, other types of suitable devices will occur to those of skill in the art. For example, a personal digital assistant (“PDA”) could be fitted with a custom sleeve allowing it to connect to the adapter, or alternatively, the PDA could communicate the timing instruction by infrared or other wireless communication methods, where the adapter is equipped to receive such communications. A personal computer, such as a laptop, could also have a programming application installed thereon to allow the user to select or program the timing instructions and could be equipped with a communications interface corresponding to the programming interface of the adapter.

The above-described embodiments of the invention are intended to be examples of the present invention and alterations and modifications may be effected thereto, by those of skill in the art, without departing from the scope of the invention which is defined solely by the claims appended hereto.

We claim:

1. A system for control of electrical devices, comprising:
at least one adapter having an electrical power interface operable to be connected to an electrical power source, a switch coupled to said electrical power interface and moveable between a closed position, wherein an electrical power circuit is supplied to an electrical device coupled to said power source, and an open position, wherein said electrical power circuit is open to disconnect said electrical device from said electrical power source, a first timer module coupled to said switch and operable to maintain time information and at least one timing instruction associated with said time information, said timing instruction including at least one timing criterion and a power instruction associated with said switch, and a programming interface operable to receive a change to said time information and said at least one timing instruction;
a programming module having a display for displaying said time information and said at least one timing instruction, an input interface for allowing a user to modify said time information and said at least one timing instruction, and operable to be connected to said programming interface of said adapter via a communications interface to update said at least one modified timing instruction to said adapter via said programming interface, after which said programming module can be operatively disconnected from said adapter,
wherein said adapter is operable to control said second electrical power circuit after said programming module is disconnected therefrom.

2. The system for control of electrical devices of claim 1, wherein said programming module additionally comprises a second timer module operable to maintain said at least one timing instruction.

3. The system for control of electrical devices of claim 1, wherein said second timer module is operable to maintain said time information.

4. The system for control of electrical devices of claim 3, wherein said programming module is additionally comprised of an audible alarm module and said programming module is operable to trigger said audible alarm module based on at least one audible alarm timing instructions programmed via said input interface.

5. The system for control of electrical devices of claim 4, wherein said at least one audible alarm timing instructions correspond to one of said at least one timing instructions.

6. The system for control of electrical devices of claim 4, wherein said programming module is a travel alarm clock.

7. The system for control of electrical devices of claim 1, having at least two of said adapters, and wherein said second timer module of said programming module is operable to maintain at least two subsets of said timing instructions for at least two of said adapters.

8. The system for control of electrical devices of claim 7, wherein each of said adapters is provided a separate identification, wherein said programming module is operable to associate each of said adapters with at least one of said at least two subsets of said timing instructions based on said separate identifications.

9. The system for control of electrical devices of claim 8, wherein said programming module is operable to communicate said at least one of said at least two subsets of said timing instructions selectively according to said identification of said adapter to which said programming module is connected.

10. The system for control of electrical devices of claim 1, wherein said at least one timing criterion is at least partially composed of a pre-set time.

11. The system for control of electrical devices of claim 1, wherein said adapter additionally comprises an independent power supply to power said adapter when said electrical power supply experiences a power fluctuation.

12. The system for control of electrical devices of claim 11, wherein said independent power supply comprises a battery.

13. The system for control of electrical devices of claim 1, wherein said programming module is a personal digital assistant.

14. The system for control of electrical devices of claim 1, wherein said programming interface and said communications interface are comprised of a set of electrical contacts.

15. The system for control of electrical devices of claim 1, wherein said programming interface and said communications interface are mulit-pin electrical connectors.

16. The system for control of electrical devices of claim 1, wherein said programming interface comprises an infrared receiver and said communications interface comprises an infrared transmitter.

17. The system for control of electrical devices of claim 1, wherein said programming interface and said communications interface are powerline communications networking adapters.

18. The system for control of electrical devices of claim 1, wherein said adapter includes an AC/DC adapter to convert an alternating current from said electrical power supply to a direct current for operation of said timer module.

19. The system for control of electrical devices of claim 1, wherein said electrical device is a remote car starter.

20. The system for control of electrical devices of claim 1, wherein said electrical device is an automotive block heater.

21. A programming module for use with programmable power adapters, comprising:
a display for displaying time information and at least one timing instruction associated with said time information and maintained by a programmable power adapter;
an input interface for allowing a user to make at least one modification said time information and said at least one timing instruction; and
a communications interface operable to communicate said at least one modification to a programming interface of said adapter operable to control a power supply to an electrical device in accordance with said at least one timing instruction.

22. The programming module of claim 21, additionally comprising:
a timer module operable to maintain said time information and at least one timing instruction.

23. The programming module of claim 22, wherein said timer module is operable to compare said at least one timing instruction with at least one deployed timing instruction on said adapter.

24. The programming module of claim 21, wherein said programming module is a personal digital assistant.

25. The programming module of claim 21, wherein said programming module is a computer.

26. The programming module of claim 21, wherein said input interface consists of at least one button.

27. The programming module of claim 21, wherein said communications interface is an infrared transmitter.

28. The programming module of claim 21, wherein said communications interface is a powerline communications network adapter.

29. The programming module of claim 21, wherein said communications interface is a wireless network adapter.

30. The programming module of claim 21, wherein said communications interface is a set of electrical contacts.

31. An adapter for controlling an electrical device, comprising:
an electrical power interface for connection to an electrical power supply;
an electrical power outlet operable to supply electrical power to an electrical device;
a switch connected to said electrical power supply and operable to move between a closed position, whereby said electrical power is provided to said electrical device, and an open position, whereby said electrical power is disconnected from said electrical device;
a timer module coupled to and operable to move said switch between said closed position and said open position based on time information and at least one timing instruction associated with said time information maintained by said timer module, said timing instruction including at least one criterion and a power instruction associated with said switch; and
a programming interface operable to receive a change to said time information and said at least one timing instruction.

32. The adapter for controlling an electrical device of claim 31, wherein said electrical power interface is operable to be connected to a household electrical power outlet.

33. The adapter for controlling an electrical device of claim 31, wherein said electrical power interface is operable to be connected to an automotive battery.

34. The adapter for controlling an electrical device of claim 33, wherein said electrical device is a remote car starter.

35. The adapter for controlling an electrical device of claim 31, wherein said programming interface is a set of electrical contacts.

36. The adapter for controlling an electrical device of claim 31, wherein said programming interface is a wireless network adapter.

37. The adapter for controlling an electrical device of claim 31, additionally comprising:
a sensor operable to provide sensory information to said timer module associated with at least one of said at least one timing instruction.

38. The adapter for controlling an electrical device of claim 37, wherein said sensor is a photo sensor.

39. The adapter for controlling an electrical device of claim 37, wherein said sensor is a motion sensor.

40. The adapter for controlling an electrical device of claim 37, wherein said sensor is a microphone.

41. The adapter for controlling an electrical device of claim 37, wherein said sensor is a thermostat.
